(19) United States
(12) Patent Application Publication
(10) Pub. No.: US 2009/0150479 A1
(43) Pub. Date: Jun. 11, 2009

(54) Web Feeds for Work List Publishing

(76) Inventors: Peter Eberlein, Malsch (DE); Guenter Pecht-Seibert, Muehlhausen (DE)

Correspondence Address: MINTZ, LEVIN, COHN, FERRIS, GLOVSKY & POPEO, P.C., ONE FINANCIAL CENTER, BOSTON, MA, 02111, US

(21) Appl. No.: 11/952,931

(22) Filed: Dec. 7, 2007

(51) Int. Cl. G06F 15/16

(52) U.S. Cl. 709/203

(57) ABSTRACT

The subject matter disclosed herein provides methods and apparatus, including computer program products, for providing web feeds for work list publishing. In one aspect, there is provided a computer-implemented method. The method may receiving, at a web feed generator, a request for a web feed including one or more tasks, when a cache indicates that an additional task is available at the web feed generator. The web feed generator may generate the web feed including the one or more tasks. The web feed generator may provide the generated web feed including the one or more tasks to a user interface to enable presentation of the web feed. Related apparatus, systems, methods, and articles are also described.

### FIELD

The subject matter disclosed herein relates to web feeds.

### BACKGROUND

Work processes in enterprise resource planning (ERP) systems are automated to a large degree but typically do require some user interaction. The ERP system may provide information regarding a task by sending an indication, such as a message, to a computer, where a user may be made aware of the new task. The ERP system may provide task information and present the task information as a work list. The work list is often associated with a workflow (also referred to as a work process). Moreover, the work list may be sent to a client application of the ERP system to enable the user to complete tasks of a workflow.

### SUMMARY

The subject matter disclosed herein provides methods and apparatus, including computer program products, for providing web feeds for work list publishing.

In one aspect, there is provided a computer-implemented method. The method may receive, at a web feed generator, a request for a web feed including at least one task, when a cache indicates that an additional task is available at the web feed generator. The web feed generator may generate the web feed including the at least one task. The web feed generator may provide the generated web feed including the at least one task to a user interface to enable presentation of the web feed.

There may also be provided one or more of the following variations. The request for the web feed may include information identifying a user at the user interface. The request may be received, when the indication represents at least one of a flag and an empty cache. The request may be forwarded to the web feed generator, when the indication represents at least one of the flag and the empty cache. The request may be denied, when the cache indicates that an additional task is not available at the web feed generator. The web feed may be generated as an RSS (real simple syndication) feed including an URL. The web feed may be generated using the at least one task received from at least one business object. The business object may be queried based on an identity of a user. The results of any query may provide the at least one task specific to a user's role.

In some implementations, the subject matter described herein provides the advantage of retrieving up-to-date tasks from a user interface.

Articles are also described that comprise a computer-readable medium (e.g., tangibly embodied machine-readable medium) operable to cause one or more machines to result in operations described herein. Similarly, a system (e.g., a computer) is described that may include a processor and a memory coupled to the processor. The memory may include one or more programs that cause the processor to perform one or more of the operations described herein.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed embodiments. In the drawings,

FIG. 1 shows a block diagram of a system for providing work lists via web feeds to clients;

FIG. 2 shows a process for providing work lists;

FIG. 3 shows an example of a work list including a web feed; and

FIG. 4 shows a block diagram of another system for providing work lists via web feeds to clients.

Like reference symbols in the various drawings indicate like elements.

### DETAILED DESCRIPTION

The implementations set forth in the following description do not represent all implementations consistent with the subject matter described herein. Instead, they are merely some examples consistent with certain aspects related to the described subject matter.

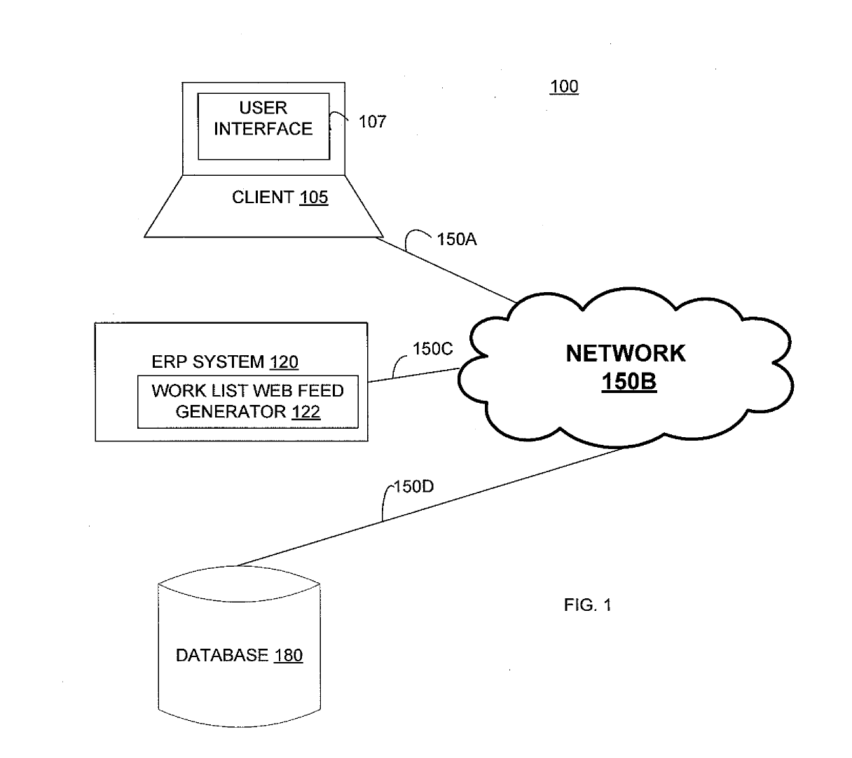

FIG. 1 depicts a block diagram of a system 100 including a client 105 (e.g., a computer, a processor, and the like), an ERP system 120, a database 180, and a network 150A-D. The client 105 further includes an application, such as a user interface 107.

The user interface 107 may be any application used to interface with other applications, such as ERP system 120. For example, user interface 107 may include a browser or a client application to interface with applications and services. In some implementations, user interface 107 is implemented as a so-called “plug-in” to other software, such as a groupware client. In some implementations, user interface 107 includes a web feed reader. A web feed reader refers to an application that aggregates published web content. The term web feed refers to data formatted (e.g., using RSS (real simple syndication)). Web feeds may allow a user of user interface 107 to present work lists of ERP system 120.

User interface 107 may make one or more requests for a web feed including a work list to ERP system 120. When user interface 107 makes a request to ERP system 120 through network 150A-C, the request (a HTTP (Hypertext Transfer Protocol) request) may include one or more of the following: a username, a user identifier (ID), an URL (Uniform Resource Locator), and any other data.

ERP system 120 may include one or more components (e.g., applications, services, applets, and the like) to provide an integrated system for the data and processes of an enterprise (e.g., an organization).

ERP system 120 further includes a work list web feed generator 122. Work list web feed generator 122 includes one or more of the following functions; retrieves user-specific data; generates a web feed including a work list; generates, based on the retrieved user-specific data, a web feed including a work list; retrieves one or more tasks for the work list by querying one or more business objects; and provides the generated web feed including the work list to user interface 107. User-specific data refers to data, such as a task or a work list, specific to a user and/or user interface 107. For example, each of a plurality of users of system 100 may have a work list specific to that user.

Although FIG. 1 depicts ERP system 120, any other application may be used as well including a customer relationship management (CRM) application, a product lifecycle management application, a supply chain management (SCM) application, and a supplier relationship management application.

Database 180 may include business objects, tasks for a work list, and information describing one or more users of ERP system 120 and/or user interface 107. Task information represents one or more tasks (e.g., items of work, jobs, and the like) that should be completed, such as tasks of a work list that need to be completed by a user of user interface 107. Data about users may include one or more of the following: a username, a user ID, a password, a role (e.g., a job function, such as manager, purchaser, and the like), and any other data capable of being used to generate a user-specific work list.

Although FIG. 1 depicts ERP system 120, client 105, and database 180 at separate locations, in some implementations, ERP system 120, client 105, and database 180 may be at other locations and/or distributed among multiple locations.

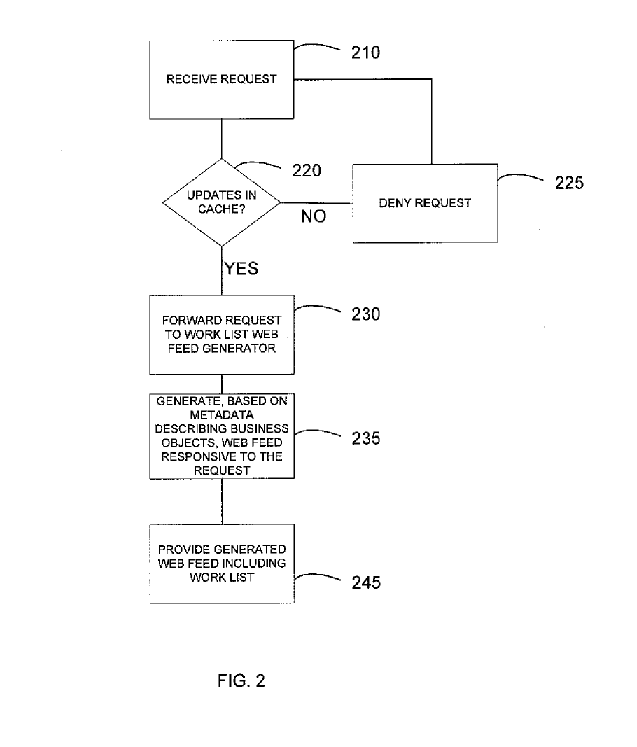

FIG. 2 shows a process 200 for providing a work list.

At 210, ERP system 120 receives a request provided by user interface 107 through network 150A-C. The received request may be a message representing a request for a work list (e.g., one or more tasks) from ERP system 120. The received message may include a request for a work list and one or more of the following; the location of the user (e.g., a Uniform Resource Locator (URL) of client 105); identity of a user (e.g., a user identifier (ID) and password); identity of the web feed to be produced (e.g., OpenOrders, MyServiceRequests, and the like); a sorting preference indicating how to sort the tasks of a work list (e.g., oldest first, urgent task first, and the like), a maximum number of tasks to include in a work list; a time span for the tasks (e.g. tasks created within the last five days); type of jobs requested; and the like.

In some implementations, the request is for a user-specific work list, such as a list of tasks to be completed by a specific user. For example, a user, such as “John,” may be interacting with ERP system 120 through user interface 107. A user-specific work list may provide John with one or more tasks, each of which is specific to John, e.g., John's identity, his role, and the like. The following is an example of a user-specific work list for “John”

Work list for John
Perform maintenance at Akron Heating
Perform Repair at Mr. Smith (Urgent)
Return vehicle to station
Submit invoices

At 220, in response to the request received at 210, ERP system 120 checks whether there are any updates responsive to the request (e.g., another, updated work list for client 105). To check for updates, ERP system 120 may check a cache to determine whether there are any new, updated web feeds including work lists for user interface 107. For example, ERP system 120 may check a cache for a flag. When the flag is set (e.g., equal to 1), ERP system 120 has an update to the web feed for client 105. When the flag is not set (e.g., equal to 0), ERP system 120 does not have an update (e.g., an additional task or work list) to provide as a web feed to client 105.

At 225, when the cache indicates that updated information for client 105 is not available, ERP system 120 denies the request received at 210. To deny the request, ERP system 120 may not respond to the request or, alternatively, respond with a message indicating a denial.

At 230, when the cache indicates that there is updated information, such as additional tasks or another work list for user interface 107, the request received at 210 is provided (e.g., sent, forwarded, made available, and the like) to the work list web feed generator 122.

At 235, work list web feed generator 122 generates a web feed including a work list to respond to the request received at 210. Moreover, the web feed may be generated based on metadata describing business objects. A business object represents a data structure including at least one of data and methods. The business object may be defined by a data type and may have associations to other business objects. A business object may also include one or more nodes (e.g., a portion of a business object) and metadata describing one or more of the following: the business object; the data of the business object (e.g., data included in a purchase order); the methods of the business object (e.g., how to generate the purchase order); associations (e.g., links) to other business objects; the structure of the business object; and any other data about the business object. Metadata may be used to manage, navigate, query, and manipulate the business object as well as other associated business objects. For example, purchase order may be represented as a business object. Moreover, the business object may have a “selling party of a purchase order” node that is associated to another business object named “selling party” having data about the business partner, such as address, billing information, and the like.

For example, a request may be received at 210 for a work list of one or more tasks, such as a work list of open (i.e., uncompleted) work orders. In response to the request, work list web feed generator 122 may send a query to one or more business objects. The business object may include data indicating whether a work order business object has an “open” status. If so, the work order business object is collected and returned to work list web feed generator 122 as a response to the query. The query response may include numerous business objects, depending on how many business objects exist that fulfill the query. The query response may also include metadata, such as each work order's ID, a user ID of the person responsible for the work order, a short description of the task (or an URL to the short description), and a link (e.g., an URL) to process the work order. The query response including metadata may be used to form a web feed (including a work list) responsive to the request received at 210. The formed web feed may be formatted for publication at user interface 107.

At 245, ERP system 120 (or work list web geed generator 122) provides to client 105 the generated web feed including the web list. The web feed may be formatted and include one or more tasks of a work list, metadata, and locations (e.g., an URL) for information associated with the work lists. The web feed may be formatted using RSS although other formats may be used as well. For example, the web feed may be an RSS including a work list of all open work orders and may be used by a web feed reader for presentation at user interface 107. Table 1 below depicts an example of a web feed including a work list of one or more tasks. The tasks are depicted at lines 10 and 18.

TABLE 1
Sample Web Feed Generated at 235 and Provided at 245.

| Line | |
|---|---|
| number | Sample Web Feed |
| 1 | <?xml version=“1.0”?> |
| 2 | <rss version=“2.0”> |
| 3 | <channel> |
| 4 | <title>Service Tasks Work list</title> |
| 5 | <link>http://erp.mycompany.com/worklists?user=john.doe/</link> |
| 6 | <description>Service Tasks for John Doe</description> |
| 7 | <language>en-us</language> |
| 8 | |
| 9 | <item> |
| 10 | <title>Perform maintenance at Akron Heating</title> |
| 11 | <link>http://erp.mycompany.com/servicetasks.html</link> |
| 12 | <description>Go to Akron Heating at 4711 Sunset Blvd. to check their |
| | pipe system.</description> |
| 13 | <pubDate>Tue, 04 May 2007 09:21:17 GMT</pubDate> |
| 14 | <guid>http://erp.mycompany.com/servicetasks.html?task=834e5843543523d75e</guid> |
| 15 | </item> |
| 16 | |
| 17 | <item> |
| 18 | <title>Perform Repair at Mr. Smith (Urgent)</title> |
| 19 | <link>http://erp.mycompany.com/servicetasks.html</link> |
| 20 | <description>Go to Mr. Smith at 911 Moonlight Rd. to repair his |
| | waste-pipe, it is clogged.</description> |
| 21 | <pubDate>Tue, 04 May 2007 08:49:12 GMT</pubDate> |
| 22 | <guid>http://erp.mycompany.com/servicetasks.html?task=834e5845326af9001b |
| | </guid> |
| 23 | </item> |
| 24 | </channel> |
| 25 | </rss> |

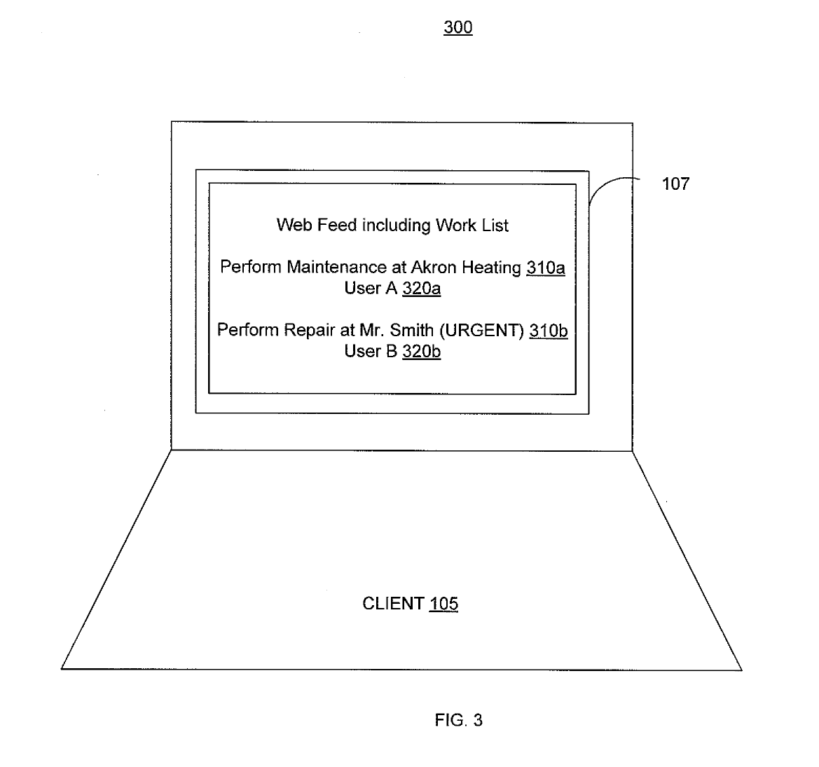

FIG. 3 depicts user interface 107 presenting a web feed including a work list of tasks 310a-b and the corresponding users 320a-b for those tasks. The tasks 310a-b correspond to the tasks at lines 10 and 18 of Table 1 above.

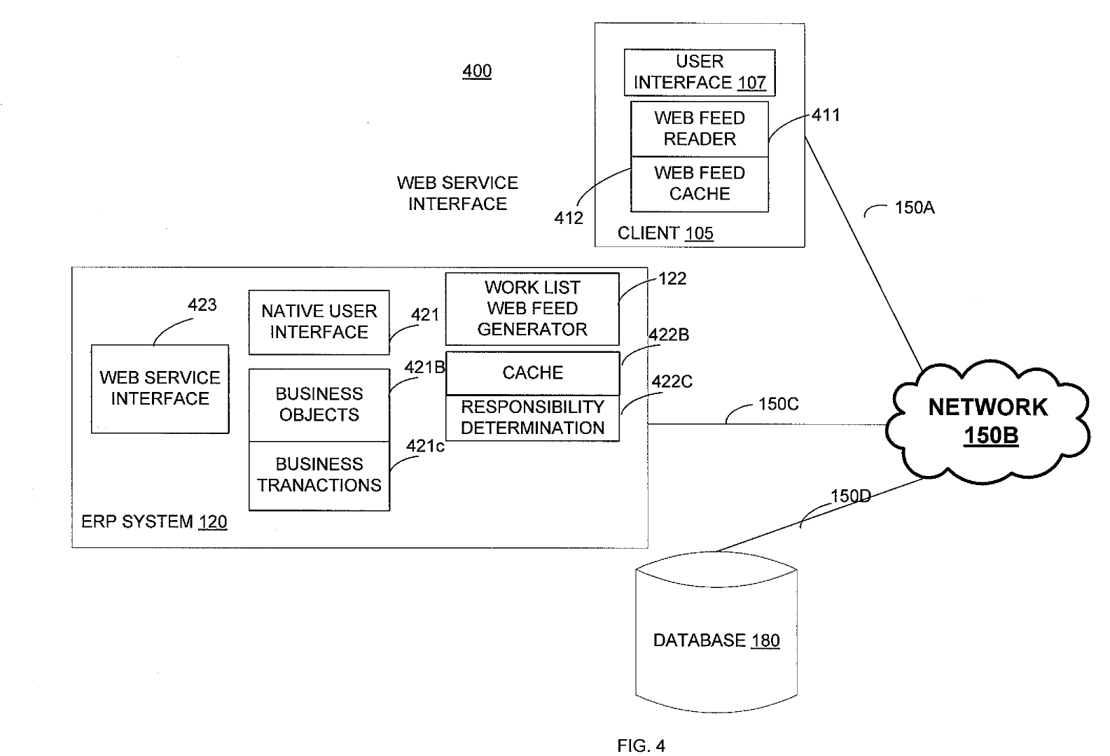

FIG. 4 depicts a block diagram of a system 400. System 400 is similar to system 100 in many respects, but includes additional features. For example, client 105 further includes a web feed reader 411 and a web feed cache 412. Moreover, ERP system 120 further includes a web service interface 423, native user interface 421, business objects 421B, business transactions 421C, cache 422B, and responsibility determination 422C.

The web feed reader 411 may be implemented as any component, such as an application or an applet, for presenting web feeds. For example, a browser may include an RSS plug-in to present a web feed. In some implementations, web feed reader 411 may present up-to-date web feeds by repeatedly sending requests to the ERP system 120. For example, web feed generator 411 may periodically poll ERP system 120 for a web feed including a work list.

Web feed cache 412 stores recently generated web feeds including work lists. For example, in some implementations, web feed cache 412 includes the most recent, updated web feed including a work list. In this example, a so-called “empty” web feed cache 412 represents that cache 412 has been purged of its web feed. On the other hand, when web feed cache 412 is “not empty,” web feed cache 312 includes a newer, updated web feed including a work list of one or more tasks. As described above at 220, when the web feed cache 412 indicates updated information is available (e.g., cache is empty or a flag is set to 1), a request received at 210 is forwarded to work list web feed generator 122. When web feed cache 412 indicates updated information is not available (e.g., cache includes the web feed or a flag is set to 0), the request received at 220 is not forwarded to work list web feed generator 122. Instead, a web feed including the work list (stored at web feed cache 412) is provided to web feed reader 411 for presentation at user interface 107.

Although web feed cache 412 is depicted at client 105, the web feed cache may be located anywhere (e.g., ERP system 120) and in multiple locations. For example, web feed cache 412 may implemented as cache 422B as well.

The native user interface 421 may be used to interface with one or more business objects 421B. Native user interface 421 may be used to assign responsibility for a task published to a group of people (e.g. to record in the backend system that a service technician accepts the service request to visit a certain customer and to prevent another service technician from unnecessarily visiting the same customer). Native user interface 421 may be used to process a task (e.g. to grant access rights to a new user as a result of a task requesting such access rights be granted).

Business objects 421B may include one or more instantiated business objects, some of which may be persisted at database 180. Business objects 421B may be queried, based on metadata describing the business object, to identify tasks for the work list provided to client 105.

ERP system 120 may also include one or more business transactions 421C defining one or more work flows of ERP system 120. For example, business transactions 421C may define work to be performed, work that has been completed, and identifiers (e.g., user IDs, roles, and the like) of one or more users associated with ERP system 120 and/or user interface 107. For example, business transactions 421C may define a workflow of a work order, a purchase order, and the like.

The web feed generator 122 may generate a web feed from the one or more business objects 421B. The web feeds may include metadata about a particular business transaction to be performed. The web feed generator 122 generates the web feed by formatting the business objects 421B into XML files including URLs of work lists. These URLs of work lists point to work lists with additional information for a specific work order.

For example, the URL may provide the location of additional information including a detailed description of a task, deadline to complete the task, an entity responsible for completing the task (e.g., a user ID), when the task was created, and the like. A task may then be completed by processing the business object associated with the task (e.g. granting access rights to a new user as a result of a task requesting such access rights be granted). The business object may have an identity node identifying the user for which access rights were requested. A system administrator, navigating native user interface 421, can add access rights to this business object by modifying the attributes of the identity node.

The web feed generator 122 may generate a web feed including a work list using responsibility determination 422C. Responsibility determination 422C provides rules for determining whether a user is responsible for a task (e.g., a data item of a business object) based on a username or user ID included in the request message. The responsibility determination 422C may filter business objects 421B to identify one or more tasks based on the rules of responsibility determination 422C. The use of responsibility determination 422C enables a web feed including a work list to be further specified (e.g., refined, personalized, and the like) for a specific user at user interface 107.

The web services interfaces 423 include a collection of interfaces to interface with web services. A web service is a service accessible using one or more standard protocols. Some examples of web services include: web services to create, update, or delete business objects; web services to create, update, or delete a service request; and the like.

In some implementations, system 400 of FIG. 4 may also implement process 200 of FIG. 2.

At 210, user interface 107 and/or web feed reader 411 may send a request to ERP system 120 through network 150A-C. The received request may request a web feed including a work list of one or more tasks at ERP system 120.

At 220, ERP system 120 checks whether there any updates. For example, ERP system 120 may check cache 422B to determine whether there are any new, updated web feeds.

At 225, when the cache 422B indicates that updated information is not available at ERP system 120, ERP system 120 denies the received request.

At 230, when the cache 422B indicates that there is updated information, such as an updated work list for client 105, the request received at 210 is provided (e.g., sent, forwarded, and the like) to work list web feed generator 122.

At 235, to generate a web feed including a work list, web feed generator 122 sends a query to business objects 421B requesting one or more business objects for all tasks of a certain type. Business objects 421B in turn gather from business transactions 421C all data to fulfill the query. Business transactions 421C provide encapsulation of transactional data for tasks of a certain type (e.g., so-called “open” tasks). Once encapsulated at business transactions 421B, a work list is generated by organizing and storing the data representative of tasks. In some implementations, the data is organized and sorted by task, ID, and status. Metadata describing the business objects are also determined and sent to the work list web feed generator 122. The metadata may be used to configure the work list for publishing as a web feed. Next, work list web feed generator 122 then filters the metadata by running it through responsibility determination 422C. The responsibility determination 422C determines which work list to generate for a specific request. The responsibility determination 422C may act as a filter that removes from the work list of all open tasks those tasks that are not responsive to the request by user interface 107. Web feed generator 122 formats the web feed including the work list. Work list web feed generator 122 then provides the formatted web feed to web feed reader 411 and/or user interface 107.

In some implementations, the subject matter described herein may provide a service able to combine work lists with external services, such as so-called “mashups,” map data, and the like. These external services may provide additional context-specific values. For example, a work list of service appointments including address information may be piped to a map service, so that the user can be presented the service task together with a map of where the service has to be provided. In another example, a work list of customers to call for a survey can provide their telephone numbers that can be piped to a VoIP (voice-over-Internet-Protocol) phone to establish the call without the user having to key in the number manually. In some implementations, a user that has to process multiple tasks can aggregate them all into one work list and afterwards sort them by priority. In this way, a more important task is not missed because the client is working on less important tasks of a different work list or not checking other work lists at the same time.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. Although FIG. 1 depicts network 150A-D, components of system 100 may be interconnected by any form or medium of communication, example of which include point-to-point links, a bus, a local area network (“LAN”), a wide area network (“WAN”), an intranet, and the Internet.

The foregoing description is intended to illustrate but not to limit the scope of the invention, which is defined by the scope of the appended claims. Other embodiments are within the scope of the following claims.

What is claimed is:

1. A computer-implemented method comprising:
receiving, at a web feed generator, a request for a web feed including at least one task, when there is an indication that an additional task is available at the web feed generator;
generating, at the web feed generator, the web feed including the at least one task; and
providing the generated web feed including the at least one task to a user interface to enable presentation of the web feed.

2. The computer-implemented method of claim 1, wherein receiving further comprises:
receiving the request for the web feed including information identifying a user at the user interface.

3. The computer-implemented method of claim 1, wherein receiving further comprises:
receiving, at the web feed generator, the request, when the indication represents at least one of a flag and an empty cache.

4. The computer-implemented method of claim 1 further comprises:
forwarding the request to the web feed generator, when the indication represents at least one of the flag and the empty cache.

5. The computer-implemented method of claim 1 further comprising:
denying the request, when the cache indicates that an additional task is not available at the web feed generator.

6. The computer-implemented method of claim 1, wherein generating further comprises:
generating the web feed as an RSS (real simple syndication) feed including an URL and the at least one task of a work list of an enterprise resource planning (ERP) system.

7. The computer-implemented method of claim 1, wherein generating further comprises:
generating the web feed by receiving the at least one task from at least one business object.

8. The computer-implemented method of claim 1, wherein generating further comprises:
querying, based on an identity of a user, at least one business object, the results of the query providing the at least one task specific to the user.

9. A computer-readable medium comprising instructions that when performed by a computer result in operations comprising:
receiving, at a web feed generator, a request for a web feed including at least one task, when there is an indication that an additional task is available at the web feed generator;
generating, at the web feed generator, the web feed including the at least one task; and
providing the generated web feed including the at least one task to a user interface to enable presentation of the web feed.

10. The computer-readable medium of claim 9, wherein receiving further comprises:
receiving the request for the web feed including information identifying a user at the user interface.

11. The computer-readable medium of claim 9, wherein receiving further comprises:
receiving the request, when the indication represents at least one of a flag and an empty cache.

12. The computer-readable medium of claim 9 further comprising:
forwarding, at a web feed generator, the request to the web feed generator, when the indication represents at least one of the flag and the empty cache.

13. The computer-readable medium of claim 9 further comprising:
denying the request, when the cache indicates that an additional task is not available at the web feed generator.

14. The computer-readable medium of claim 9, wherein generating further comprises:
generating the web feed as an RSS (real simple syndication) feed including an URL and the at least one task of a work list.

15. The computer-readable medium of claim 9, wherein generating further comprises:
generating the web feed by receiving the at least one task from at least one business object.

16. The computer-readable medium of claim 9, wherein generating further comprises:
querying, based on an identity of a user, at least one business object, the results of the query providing the at least one task specific to the user.

17. A system comprising:
a processor; and
a memory, wherein the processor and the memory are configured to perform a method comprising:
receiving, at a web feed generator, a request for a web feed including at least one task, when there is an indication that an additional task is available at the web feed generator;
generating, at the web feed generator, the web feed including the at least one task; and
providing the generated web feed including the at least one task to a user interface to enable presentation of the web feed.

18. The system of claim 17, wherein receiving further comprises:
receiving the request for the web feed including information identifying a user at the user interface.

19. The system of claim 17, wherein receiving further comprises:
receiving the request, when the indication represents at least one of a flag and an empty cache.

20. The system of claim 17 further comprising:
forwarding the request to the web feed generator, when the indication represents at least one of the flag and the empty cache.
